(19) United States
(12) Patent Application Publication
(10) Pub. No.: US 2012/0291407 A1
(43) Pub. Date: Nov. 22, 2012

(54) Air Filter Sleeve

(76) Inventor: Minh Ngoc Nguyen, Houston, TX (US)

(21) Appl. No.: 13/037,357

(22) Filed: May 17, 2011

(51) Int. Cl. F24F 13/20; B01D 46/00

(52) U.S. Cl. 55/385.1

(57) ABSTRACT

This invention generally relates to the use of an Air Filter Sleeve to protect an air conditioning's air filter from getting dirty. The idea is to keep the original air conditioning's air filter clean to help consumer avoid high cost on air conditioning's air filters replacement.

### BACKGROUND OF INVENTION

During this hard time economic struggle, I were at the store looking for air conditioning's air filters for my house. Cost of an air conditioning filter always had been an issue for me, the average cost of a good air conditioning's air filter is $ 10.00/each. I was looking at the filters and try to figure out why is it cost so much, by doing some research I found out because of the way it design and the structure of it makes it cost more because of more and better air filtration materials are used. I then come up with an idea what if I spend money to buy a good air conditioning air filter once and never have to replace it for a long time that is how I come up with this invention and the title of my invention is Air Filter Sleeve.

### SUMMARY OF INVENTION

The air filter sleeve is design to wrap around the air conditioning air filter on the air inlet side. The invention of an Air Filter Sleeve provided extra air filtration for air conditioning system. The idea is to protect the air conditioning's air filter from getting dirty to avoid high cost replacement.

### BRIEF DESCRIPTION OF FIGURES

FIG. 1 is a top view of a regular air conditioning's air filter

FIG. 2 is a bottom view of an Air Filter Sleeve with rubber band embedded at 1

FIG. 3 is a top view of and Air Filter Sleeve

FIG. 4 is a over view how an Air Filter Sleeve will position on a regular air conditioning's air filter

FIG. 5 is a top view of an Air Filter Sleeve that is complete installed on an air conditioning's air filter

FIG. 6 is bottom view of an Air Filter Sleeve that is complete installed on an air conditioning's air filter, rubber band embedded shown at 1

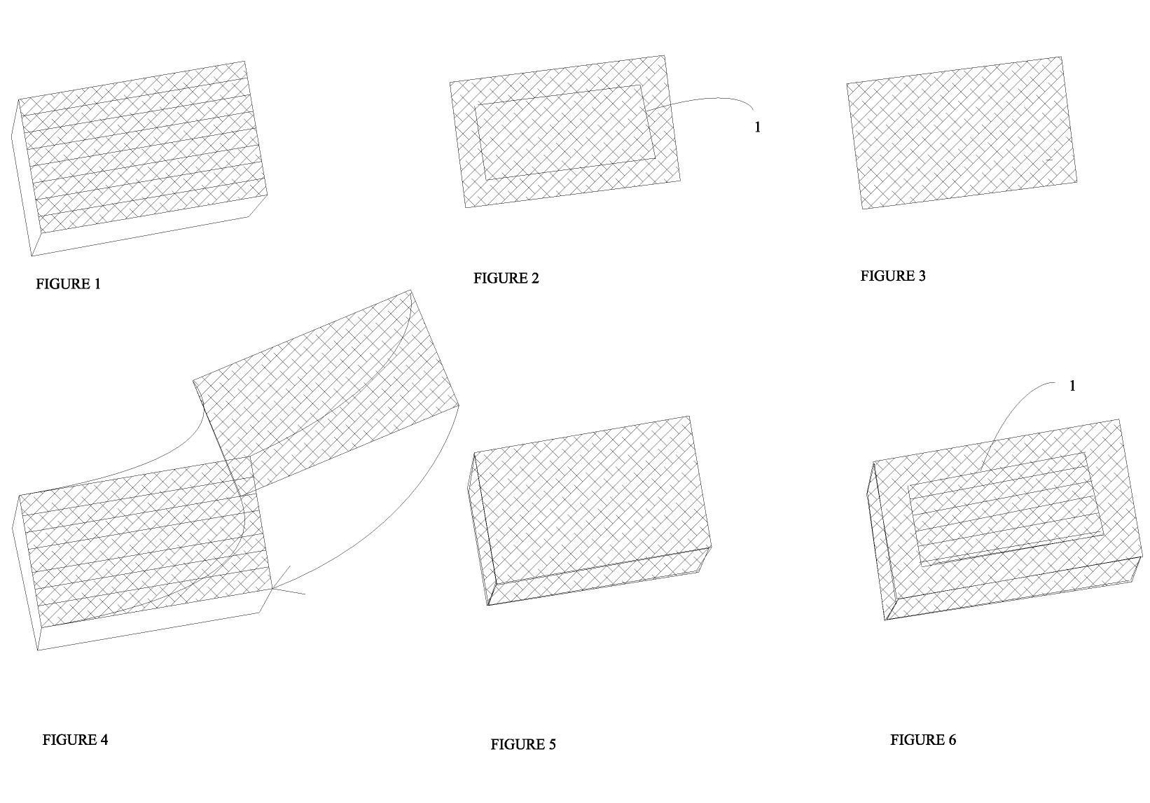

### DESCRIPTION ON THE INVENTION

Purpose of the Air filter Sleeve is used to help pre filtration the air on an air conditioning system. Air filter sleeve is made with a thin air filter material with rubber bend embedded around the edge for easy installation as shown at 1 on FIG. 2, Air filter Sleeve is specialize to fit each shape and size of air conditioning's air filter on the market. The rubber band around the Air filter Sleeve will secure and give the Air filter sleeve a stretch fit around an air conditioning's air filter. Install the Air filter Sleeve in an air conditioning system simply by selecting appropriate air filter Sleeve, remove the air conditioning's air filter, use hands stretch and wrap the Air Filter Sleeve over air inlet side of air conditioning's air filter, install air filter back in the air conditioning system. As the Air passed through air filter sleeve, air conditioning air filter, condenser, then continuing to the air conditioning vent to provide consumer cool and clean air.

1. the way of use an Air Filter Sleeve to protect an air conditioning's air filter from getting dirty on all types of air conditioning system.
